(19) United States
(12) Patent Application Publication
(10) Pub. No.: US 2024/0070453 A1
(43) Pub. Date: Feb. 29, 2024

(54) METHOD AND APPARATUS WITH NEURAL NETWORK TRAINING

(71) Applicants: SAMSUNG ELECTRONICS CO., LTD., Suwon-si (KR); Seoul National University R&DB Foundation, Seoul (KR)

(72) Inventors: Nam Soo KIM, Seoul (KR); Jiwon YOON, Seoul (KR)

(73) Assignees: SAMSUNG ELECTRONICS CO., LTD., Suwon-si (KR); Seoul National University R&DB Foundation, Seoul (KR)

(21) Appl. No.: 18/108,727

(22) Filed: Feb. 13, 2023

(30) Foreign Application Priority Data
Aug. 23, 2022 (KR) 10-2022-0105734

(51) Int. Cl. G06N 3/08

(52) U.S. Cl. CPC G06N 3/08

(57) ABSTRACT

Provided is a method and an apparatus with neural network (NN) training. A method of operating a neural network model includes predicting first latent target data based on source data and based on target data corresponding to the source data, predicting second latent target data based on the source data and based on constant data, and training the NN model based on the first latent target data and the predicted second latent target data; the first latent target data and the target data have a many-to-one relationship.

### CROSS-REFERENCE TO RELATED APPLICATIONS

This application claims the benefit under 35 USC § 119(a) of Korean Patent Application No. 10-2022-0105734, filed on Aug. 23, 2022, in the Korean Intellectual Property Office, the entire disclosure of which is incorporated herein by reference for all purposes.

### BACKGROUND

### 1. Field

The following description relates to a method and an apparatus with neural network training.

### 2. Description of Related Art

Research is being conducted on trying to apply efficient learning-based pattern recognition methods in computers. The research includes research on neural networks (NNs) obtained by modeling characteristics of biological neurons using mathematical operations of computers. To address an objective of a NN classifying an input pattern (determining which predetermined group the input pattern mostly likely belongs to), a learning algorithm is employed. Through the learning algorithm, the NN may be configured (trained) to map input patterns to outputs. A NN and training thereof provides a general capability of generating a relatively correct output with respect to an input pattern that may not have been used for training the NN.

The above description is information the inventor(s) acquired during the course of conceiving the present disclosure, or already possessed at the time, and was not necessarily publicly known before the present application (or a predecessor thereof) was filed.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a method of operating a neural network model includes predicting first latent target data based on source data and based on target data corresponding to the source data, predicting second latent target data based on the source data and based on constant data, and training the NN model based on the first latent target data and the predicted second latent target data; the first latent target data and the target data have a many-to-one relationship.

The training of the NN model may be based on a difference between the first latent target data and the second latent target data.

The predicting of the first latent target data may be based on a connectionist temporal classification (CTC) algorithm.

The predicting of the first latent target data may include masking out a portion of the target data and predicting the first latent target data by receiving the source data and a remainder of the target data that is not masked out.

The first latent target data may be predicted by using cross entropy as a loss function.

The training of the NN model may include training the NN model based on a first loss function determined based on a difference between the target data and the first latent target data, a second loss function determined based on a difference between the target data and the second latent target data, and/or a third loss function determined based on a difference between the first latent target data and the second latent target data.

The training of the NN model may include training the NN model to minimize a final loss function determined based on the first loss function, the second loss function, and/or the third loss function

The method may further include outputting a source vector generated based on the source data, and generating a target vector based on the target data, wherein the first latent target data is predicted based on the source vector and the target vector, and the second latent target data may be predicted based on the source vector.

The source data and the target data may include time-series data comprising portions of data captured in sequence at respective different times.

In another general aspect, an electronic device includes one or more processors and a memory storing instructions configured to, when executed by the one or more processors, cause the one or more processors to: predict first latent target data by receiving source data and target data, predict second latent target data by receiving the source data and constant data, train a neural network (NN) model based on the received first latent target data and the received second latent target data; the first latent target data and the target data have a many-to-one relationship.

The instructions may be further configured to cause the one or more processors to train the NN model by minimizing a difference between the first latent target data and the second latent target data.

The instructions may be further configured to cause the one or more processors to predict the first latent target data based on a connectionist temporal classification (CTC) algorithm.

The instructions may be further configured to cause the one or more processors to mask a portion of the target data and predict the first latent target data by receiving the source data and the masked target data.

The instructions may be further configured to cause the one or more processors to predict the first latent target data by using cross entropy as a loss function.

The instructions may be further configured to cause the one or more processors to train the NN model based on either a first loss function determined based on a difference between the target data and the first latent target data, a second loss function determined based on a difference between the target data and the second latent target data, and/or a third loss function determined based on a difference between the first latent target data and the second latent target data.

The instructions may be further configured to cause the one or more processors to train the NN model to minimize a final loss function determined based on either the first loss function, the second loss function, or the third loss function.

The instructions may be further configured to cause the one or more processors to output a source vector corresponding to the source data by receiving the source data, output a target vector corresponding to the target data by receiving the target data, predict the first latent target data by receiving the source vector and the target vector, and predict the second latent target data by receiving the source vector.

The source data and the target data may comprise time-series data.

A non-transitory computer-readable storage medium may store instructions that, when executed by a processor, cause the processor to perform any of the methods.

The NN model may be configured to operate as a teacher model and as a student model.

Other features and aspects will be apparent from the following detailed description, the drawings, and the claims.

### BRIEF DESCRIPTION OF THE DRAWINGS

FIG. 1 illustrates an example of a deep learning calculation method using a neural network (NN), according to one or more embodiments.

FIG. 2 illustrates a knowledge distillation method according to related art.

FIG. 3 illustrates an example of an electronic device, according to one or more embodiments.

FIG. 4 illustrates an example of a knowledge distillation method, according to one or more embodiments.

FIG. 5A illustrates an example of predicting first latent target data based on a connectionist temporal classification (CTC) algorithm, according to one or more embodiments.

FIG. 5B illustrates an example of predicting first latent target data using cross entropy as a loss function, according to one or more embodiments.

FIG. 6 illustrates an example of operating a NN model, according to one or more embodiments.

FIG. 7 illustrates an example configuration of an electronic device, according to one or more embodiments.

Throughout the drawings and the detailed description, unless otherwise described or provided, the same or like drawing reference numerals will be understood to refer to the same or like elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known after an understanding of the disclosure of this application may be omitted for increased clarity and conciseness.

The features described herein may be embodied in different forms and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

The terminology used herein is for describing various examples only and is not to be used to limit the disclosure. The articles “a,” “an,” and “the” are intended to include the plural forms as well, unless the context clearly indicates otherwise. As used herein, the term “and/or” includes any one and any combination of any two or more of the associated listed items. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof.

Throughout the specification, when a component or element is described as being “connected to,” “coupled to,” or “joined to” another component or element, it may be directly “connected to,” “coupled to,” or “joined to” the other component or element, or there may reasonably be one or more other components or elements intervening therebetween. When a component or element is described as being “directly connected to,” “directly coupled to,” or “directly joined to” another component or element, there can be no other elements intervening therebetween. Likewise, expressions, for example, “between” and “immediately between” and “adjacent to” and “immediately adjacent to” may also be construed as described in the foregoing.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Unless otherwise defined, all terms, including technical and scientific terms, used herein have the same meaning as commonly understood by one of ordinary skill in the art to which this disclosure pertains and based on an understanding of the disclosure of the present application. Terms, such as those defined in commonly used dictionaries, are to be interpreted as having a meaning that is consistent with their meaning in the context of the relevant art and the disclosure of the present application and are not to be interpreted in an idealized or overly formal sense unless expressly so defined herein. The use of the term “may” herein with respect to an example or embodiment, e.g., as to what an example or embodiment may include or implement, means that at least one example or embodiment exists where such a feature is included or implemented, while all examples are not limited thereto.

The examples described herein may be implemented as various types of products, such as, for example, a personal computer (PC), a laptop computer, a tablet computer, a smartphone, a television (TV), a smart home appliance, an intelligent vehicle, a kiosk, a wearable device, or any other type of computing device. Hereinafter, examples will be described in detail with reference to the accompanying drawings. In the drawings, like reference numerals refer to like components.

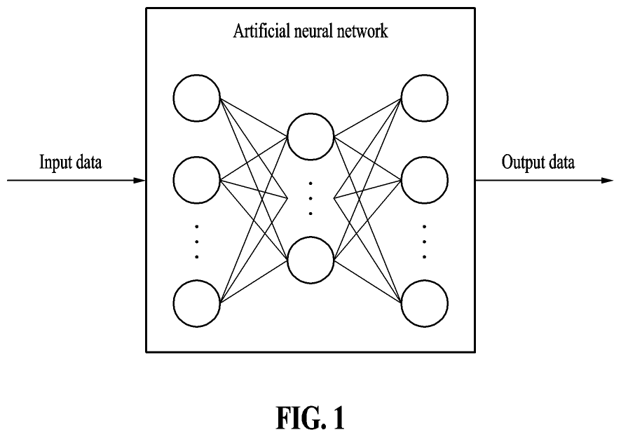

FIG. 1 illustrates an example of a deep learning calculation method using a neural network (NN), according to one or more embodiments.

An artificial intelligence (AI) algorithm, for example a deep learning algorithm, may input data into a NN, train the NN with corresponding output data outputted by the NN through operations such as convolution, and extract features (or other information) from inputs using the trained NN. In a NN, nodes or neurons are connected to each other and collectively operate to process input data. Various types of neural networks may include, for example, a convolutional neural network (CNN), a recurrent neural network (RNN), a deep belief network (DBN), and a restricted Boltzmann machine (RBM) model, to name a few examples. In a feed-forward neural network, neurons/nodes of the neural network have links to other neurons. Such links may extend through the NN in one direction, for example, in a forward direction.

FIG. 1 illustrates a structure of a NN (e.g., a CNN) for receiving input data and outputting output data. The NN may be a deep neural network including two or more layers.

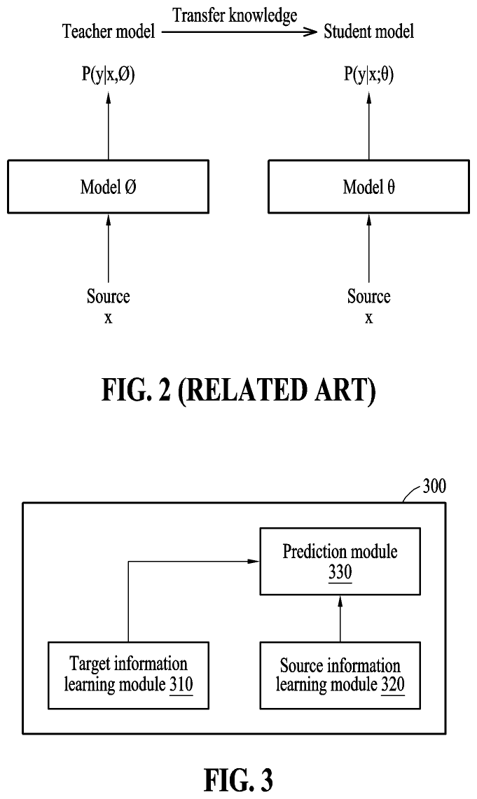

FIG. 2 illustrates an example of knowledge distillation. Knowledge distribution refers to techniques by which knowledge of one neural network model (e.g., a teacher model) is transferred to another neural network model (e.g., a student model), and the receiving/student model may have a smaller scale (fewer layers/nodes) than the source/teacher model.

Most sequence NN models receive source data as input and perform supervised learning to learn to predict target data. There are many ways to improve the performance of a sequence NN model, including knowledge distillation methods. The knowledge distillation approach may employ a teacher model (e.g., a model ϕ, as shown in FIG. 2) with excellent performance of transferring information such as a softmax value, a hidden representation, etc., to a student model (e.g., a model θ, as shown in FIG. 2) with relatively low performance and uses the transferred information for learning the student model.

In this case, both the teacher model (e.g., the model ϕ in FIG. 2) and the student model (e.g., the model θ in FIG. 2) may be learned based on supervised learning. For example, in the case of the teacher model (e.g., the model ϕ in FIG. 2), prediction data (e.g., P(y|x; ∅) value in FIG. 2) may be output by receiving source data (e.g., x in FIG. 2) and the teacher model (e.g., the model ϕ in FIG. 2) may be trained (learn) so that a difference between the teacher model's prediction data and ground truth target data (e.g., y in FIG. 2) is minimized.

Similarly, for example, in the case of a learning/student model (e.g., a model θ in FIG. 2), prediction data (e.g., P(y|x; θ) value in FIG. 2) may be output by receiving source data (e.g., x in FIG. 2) and a learning/student model (e.g., model θ in FIG. 2) may be learned so that a difference between the student model's prediction data and ground truth target data (e.g., y in FIG. 2) is minimized. In this case, the student model (e.g., the model θ in FIG. 2) may receive information such as a softmax value and a hidden representation (hidden/latent information) from the teacher model (e.g., the model ϕ in FIG. 2) and use them for learning. An inference operation may be performed using the student model (e.g., the model θ in FIG. 2) trained by the above method.

However, in the case of a teacher model, according to prior knowledge distillation methods, many computational resources (e.g., parameters, training time, etc.) may be required.

As described in detail below, according to some embodiments of knowledge distillation methods described herein, when target information is used for sequence model learning (learning a model that processes sequential data), an excellent teacher model may be generated using relatively few computational resources. Furthermore, unlike prior knowledge distillation methods, according knowledge distillation methods described herein, a teacher model and a corresponding student model may share same parameters.

FIG. 3 illustrates an example of an electronic device, according to one or more embodiments.

Referring to FIG. 3, an electronic device 300 may include a target information learning module 310, a source information learning module 320, and a prediction module 330.

The target information learning module 310 according to an example embodiment may receive target data as an input and may output vector data (also referred to as target vector data) corresponding to the target data.

The source information learning module 320 according to some embodiments may receive source data as an input and may generate and output vector data (also referred to as source vector data) corresponding to the source data. The source information learning module 320 according to an example embodiment may have a model structure such as a sequence model for processing a sequential task (e.g., voice recognition, translation, etc.). For example, in the case of a voice recognition task, the source information learning module 320 may have the same structure/model as a voice recognition model.

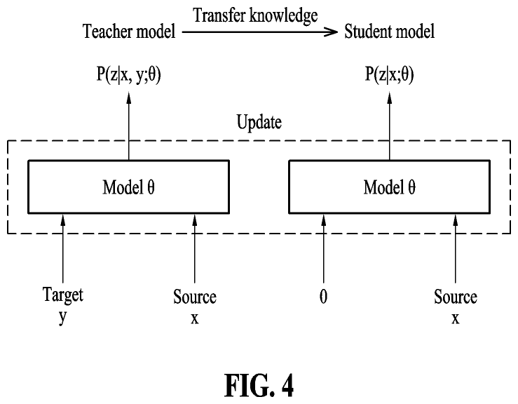

The prediction module 330 according to some embodiments may receive at least one of target vector data output from the target information learning module 310 and source vector data output from the source information learning module 320, and may output latent target data. The prediction module 330 may be learned/trained by using the latent target data according to an example embodiment. Detailed operation methods of the electronic device 300 according to an example embodiment are described below with reference to FIGS. 4 to 7.

FIG. 4 illustrates an example of knowledge distillation, according to one or more embodiments.

Referring to FIG. 4, for knowledge distillation, the teacher model and the student model may share some or all of the same parameters. The knowledge distillation method according to an example embodiment may use one model (e.g., a model θ in FIG. 4) as both a teacher model and as a student model. Although two model θs are shown in FIG. 4, in practice there may be one model θ which can operate as the teacher model or as the student model. The model θ may also be referred to as a distillation model, and may be, for example the model shown in FIG. 3 (i.e., the target information learning module 310, the source information learning module 320, and the prediction module 330). That is, in contrast with the two models shown in FIG. 2, for knowledge distillation, only one model, the distillation model θ, may exist, and it may operate as both the teacher model or student model (at different times). That is, there may be only one source information learning module 320, one target information learning module 310, and one prediction module 330; the teacher model and the student model may share all of these parameters (i.e., may have a shared model).

Regarding the teacher model, the teacher model may make a more accurate prediction target data, and information about this more accurate prediction may be transferred from the teacher model to the student model.

As shown at the left side of FIG. 4, when operating as a teacher model, the target information learning module 310 and the source information learning module 320 receive, as respective inputs, target data (e.g., y) and source data (e.g., x) and may generate, as respective outputs, a target vector and a source vector. The prediction module 330 may receive the thus-outputted target vector and source vector and based thereon predict first latent target data (e.g., P(z|x, y; θ) in FIG. 4). The first latent target data may also be referred to as [symbol] .

As shown on the right side of FIG. 4, when operating as a student model, the source information learning module 320 may receive source data (e.g., x) as an input. However, unlike the teacher case, when operating as a student model, there is no target data when an actual reasoning/inferencing operation is performed (i.e., when the student model operates autonomously for its intended purpose), and therefore target data may not be used when learning the student model. Accordingly, the target information learning module 310 may receive a constant (e.g., a zero array) to serve as an input in place of actual target data (i.e., as dummy target data). The prediction module 330 may receive respective outputs of the source information learning module 320 (generated according to the zero array) and the target information learning module 310 and based thereon predict second latent target data (e.g., P(z|x;θ) in FIG. 4). The second latent target data may also be referred to as [symbol] .

For knowledge distillation from the teacher model to the student model, learning may be performed in such a way that a difference (or distance) between the first latent target data [symbol] and the second latent target data [symbol] is reduced.

However, in the case of the teacher model, when target data (e.g., y) is simply used as an input to the prediction module 330, there may be a problem of the prediction model 330 outputting a trivial solution where the same target data (e.g., y) received by the prediction model 330 is also outputted (as the output target vector data) by the prediction model 330. With this in view, for knowledge distillation, a many-to-one relationship may be provided between the first latent target data [symbol] and the target data y. The knowledge distillation model may be implemented as a NN model.

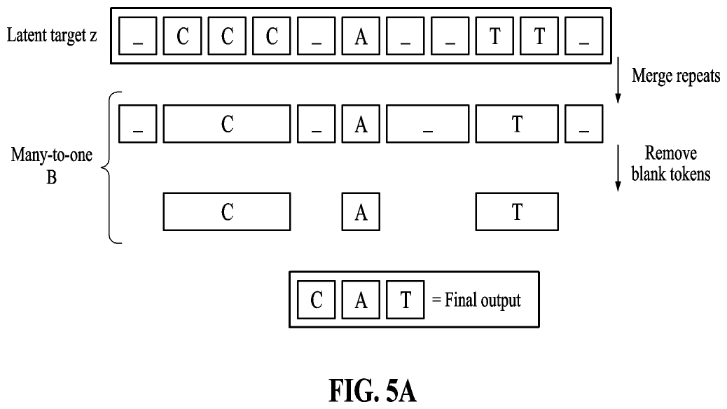

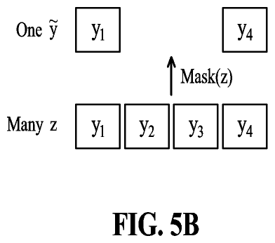

In some embodiments, the knowledge distillation model may solve the trivial-solution problem noted above by predicting z corresponding to many based on y corresponding to one (predicting many z to one y). Methods of setting the first latent target data and the target data to have a many-to-one relationship, respectively, are described with reference to FIGS. 5A to 5B.

FIG. 5A illustrates an example 500A of predicting first latent target data based on a connectionist temporal classification (CTC) algorithm, according to one or more embodiments.

Referring to FIG. 5A, according to some embodiments, the knowledge distillation model may use a CTC algorithm as an objective function. The knowledge distillation model may perform many-to-one mapping using CTC. More specifically, the knowledge distillation model may use a CTC algorithm to set the first latent target data z and the target data y to have a many-to-one relationship. This may be expressed as in Equation 1, for example.

$${max}_{θ} log P ( y \vert x ; θ ) = {max}_{θ} ( {\sum }_{f ( z ) = y} log P ( z \vert x ; θ ) ) \qquad Equation 1$$

In Equation 1, f( ) may be a CTC objective function, and other terms may be as described above.

FIG. 5B illustrates an example 500B of predicting first latent target data using cross entropy as a loss function, according to one or more embodiments.

Referring to FIG. 5B, according to some embodiments, the knowledge distillation model may use cross entropy as a loss function. However, in the case of cross entropy, unlike CTC, a many-to-one mapping may not be definable. Accordingly, the knowledge distillation model may convert a one-to-one relationship into a many-to-one relationship through masking.

Specifically, the knowledge distillation model may mask out a portion of target data and predict first latent target data based on the masked-out target data. For example, first latent target data z may be predicted by the prediction module 330 receiving target data \tilde{y} after masking the target data z. This masking may be expressed as Equation 2.

mask(z)=\tilde{y} Equation 2

Consider an example, as shown in FIG. 5B, where the target data y is y1, y2, y3, and y4. Before being masked, the target data may be the same as the first latent target data z. That is, predicting the first latent target data z may involve predicting the target data y before being masked by using the masked target data \tilde{y}. By masking the target data y, the first latent target data z and the masked target data \tilde{y} may be set in a many-to-one relationship. Through this technique, the knowledge distillation model may resolve the trivial solution problem by converting the one-to-one relationship into a many-to-one relationship.

Referring to FIG. 4, a loss function of the knowledge distillation model using CTC may be expressed as Equation 3.

CTC_loss(y,P(z|x;θ))+KD_loss(\hat{z},P(z|x;θ))+CTC_loss(y,P(z|x,y;θ)) Equation 3

The knowledge distillation model using CTC may be learned/trained such that the loss function of Equation 3 is minimized. In Equation 3, CTC_loss(y,P(z|x;θ)) may be a second loss function determined based on a difference between target data and second latent target data when operating as a student model. That is, the prediction module 330 may be learned in a way that minimizes a difference between the second latent target data and the target data.

In Equation 3, CTC_loss(y,P(z|x,y;θ)) may be a first loss function determined based on a difference between target data and first latent target data when operating as a teacher model. That is, the prediction module 330 may be learned in a way that minimizes a difference between the first latent target data and the target data.

In Equation 3, KD_loss(\hat{z},P(z|x;θ)) may be a third loss function determined based on a difference between the first latent target data and the second latent target data. That is, the prediction module 330 may be learned in a way that minimizes a difference between the first latent target data and the second latent target data.

According to some embodiments, the loss function of the knowledge distillation model using cross entropy may be expressed as Equation 4.

CE_loss(y,P(z|x;θ))+KD_loss(\hat{z},P(z|x;θ)+CE_loss(y,P(x|\tilde{y};θ) Equation 4

The knowledge distillation model using cross entropy may be learned such that the loss function of Equation 3 is minimized. In Equation 4, when operating as a student model, CE_loss(y,P(z|x;θ)) may be a second loss function determined based on a difference between target data and second latent target data. That is, the prediction module 330 may be learned in a way that minimizes a difference between the second latent target data and the target data.

In Equation 4, CE_loss(y,P(z|x,\tilde{y};θ)) may be a first loss function determined based on a difference between target data and first latent target data when operating as a teacher model. The knowledge distillation model may predict first latent target data based on the masked target data \tilde{y}. As described above, the target data y before being masked may be the same as the first latent target data z. That is, predicting the first latent target data z may have the same effect as predicting the target data y before being masked by using the masked target data \tilde{y}. The prediction module 330 may be learned in a way that minimizes a difference between the first latent target data and the target data.

In Equation 4, KD_loss(\hat{z},P(z|x;θ) may be a third loss function determined based on a difference between first latent target data and second latent target data. That is, in some embodiments, the prediction module 330 may be learned in a way that minimizes a difference between the first latent target data and the second latent target data.

Examples of using CTC and cross entropy as a loss function have been described herein but implementations are not limited thereto. Depending on the design, various loss functions that may set first latent target data and target data to have a many-to-one relationship may be adopted.

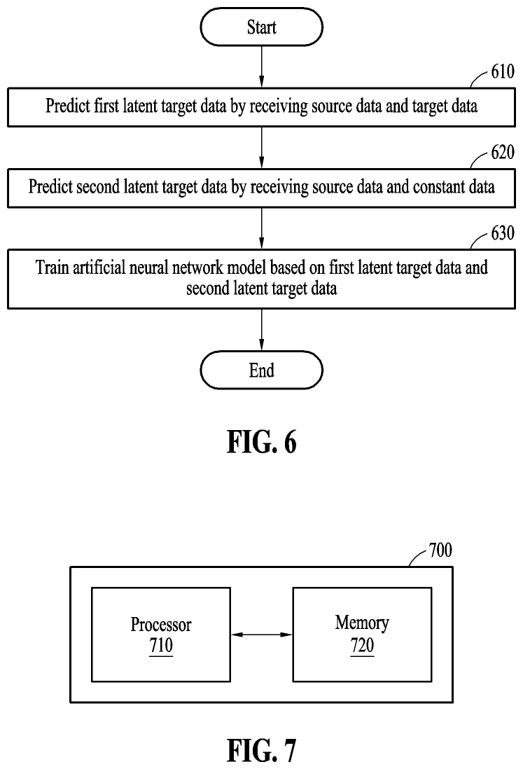

FIG. 6 illustrates an example of operating a NN model, according to one or more embodiments.

Operations 610 to 630 are described as being performed using the electronic device 300 shown in FIG. 3. However, operations 610 to 630 may be used via any other suitable electronic device and within any suitable system.

Furthermore, the operations of FIG. 6 may be performed in the shown order and manner. However, the order of some operations may be changed, or some operations may be omitted, without departing from the spirit and scope of the shown example. The operations illustrated in FIG. 6 may be performed in parallel or simultaneously.

In operation 610, the electronic device 300 may predict first latent target data by receiving source data and target data. The source data and the target data according to an example embodiment may be time series data, for example, audio data (e.g., voice data), sampled cardiac signal data, etc.

The first latent target data and the target data may be set to have a many-to-one relationship.

The electronic device 300 may predict first latent target data based on a CTC algorithm. Alternatively, the electronic device 300 may mask (e.g., screen out) a portion of the target data, receive source data and the masked target data, and predict first latent target data based thereon.

In operation 620, the electronic device 300 may predict second latent target data by receiving source data and constant data.

In operation 630, the electronic device 300 may train a NN model based on the first latent target data and the second latent target data. The electronic device 300 according to an example embodiment may train the NN model to minimize a difference between the first latent target data and the second latent target data.

FIG. 7 illustrates an example of a configuration of an electronic device, according to one or more embodiments.

Referring to FIG. 7, an electronic device 700 may include one or more processors 710 and a memory 720 (“processor” as used in the singular herein refers to “one or more processors”, in varying combinations of number/type).

The memory 720 according to an example embodiment may store computer-readable instructions. When the instructions stored in the memory 720 are executed by the processor 710, the processor 710 may process operations defined by the instructions. For example, the memory 720 may include random access memories (RAM), dynamic random access memories (DRAM), static random access memories (SRAM), or other types of non-volatile memory known in the art. The memory 720 may store a pre-trained ANN-based generative model.

One or more processors 710 according to an example embodiment may control the overall operation of the electronic device 700. The processor 710 may be a hardware-implemented apparatus having a circuit that is physically structured to execute desired operations. The desired operations may include code or instructions included in a program. The hardware-implemented apparatus may include a microprocessor, a central processing unit (CPU), graphic processing unit (GPU), a processor core, a multi-core processor, a multiprocessor, an application-specific integrated circuit (ASIC), a field-programmable gate array (FPGA), a neural processing unit (NPU, or neuroprocessor), or the like.

The processor 710 according to an example embodiment may control the electronic device 700 by executing functions and instructions for the electronic device 700 to execute. The processor 710 may control the electronic device 700 to perform at least one operation and/or function described above with reference to FIGS. 2 to 6.

The electronic device 700 controlled by the processor 710 according to an example embodiment, may train the NN model based on first latent target data and second latent target data by predicting first latent target data by receiving source data and target data and by predicting second latent target data by receiving source data.

The computing apparatuses, the electronic devices, processors, memories, displays, information output system and hardware, storage devices, and other apparatuses, devices, units, modules, and components described herein with respect to FIGS. 1-7 are implemented by or representative of hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-7 that perform the operations described in this application are performed by computing hardware, for example, by one or more processors or computers, implemented as described above implementing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media. Examples of a non-transitory computer-readable storage medium include read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above disclosure, the scope of the disclosure may also be defined by the claims and their equivalents, and all variations within the scope of the claims and their equivalents are to be construed as being included in the disclosure.

What is claimed is:

1. A method of operating a neural network model, the method comprising:
predicting first latent target data based on source data and based on target data corresponding to the source data;
predicting second latent target data based on the source data and based on constant data; and
training the NN model based on the first latent target data and the predicted second latent target data, wherein the first latent target data and the target data have a many-to-one relationship.

2. The method of claim 1, wherein the training of the NN model is based on a difference between the first latent target data and the second latent target data.

3. The method of claim 1, wherein the predicting of the first latent target data is based on a connectionist temporal classification (CTC) algorithm.

4. The method of claim 1, wherein the predicting of the first latent target data comprises:
masking out a portion of the target data; and
predicting the first latent target data by receiving the source data and a remainder of the target data that is not masked out.

5. The method of claim 4, wherein the first latent target data is predicted by using cross entropy as a loss function.

6. The method of claim 1, wherein the training of the NN model comprises:
training the NN model based on a first loss function determined based on a difference between the target data and the first latent target data, a second loss function determined based on a difference between the target data and the second latent target data, and/or a third loss function determined based on a difference between the first latent target data and the second latent target data.

7. The method of claim 6, wherein the training of the NN model comprises:
training the NN model to minimize a final loss function determined based on the first loss function, the second loss function, and/or the third loss function.

8. The method of claim 1, further comprising:
outputting a source vector generated based on the source data; and
generating a target vector based on the target data,
wherein the first latent target data is predicted based on the source vector and the target vector, and
wherein the second latent target data is predicted based on the source vector.

9. The method of claim 1, wherein the source data and the target data comprise time-series data comprising portions of data captured in sequence at respective different times.

10. A non-transitory computer-readable storage medium storing instructions that, when executed by a processor, cause the processor to perform the method of claim 1.

11. An electronic device comprising:
one or more processors;
a memory storing instructions configured to, when executed by the one or more processors, cause the one or more processors to:
predict first latent target data by receiving source data and target data;
predict second latent target data by receiving the source data and constant data;
train a neural network (NN) model based on the received first latent target data and the received second latent target data,
wherein the first latent target data and the target data have a many-to-one relationship.

12. The electronic device of claim 11, wherein the instructions are further configured to cause the one or more processors to train the NN model by minimizing a difference between the first latent target data and the second latent target data.

13. The electronic device of claim 11, wherein the instructions are further configured to cause the one or more processors to predict the first latent target data based on a connectionist temporal classification (CTC) algorithm.

14. The electronic device of claim 11, wherein the instructions are further configured to cause the one or more processors to:
mask a portion of the target data; and
predict the first latent target data by receiving the source data and the masked target data.

15. The electronic device of claim 14, wherein the instructions are further configured to cause the one or more processors to predict the first latent target data by using cross entropy as a loss function.

16. The electronic device of claim 11, wherein the instructions are further configured to cause the one or more processors to:
train the NN model based on either a first loss function determined based on a difference between the target data and the first latent target data, a second loss function determined based on a difference between the target data and the second latent target data, and/or a third loss function determined based on a difference between the first latent target data and the second latent target data.

17. The electronic device of claim 16, wherein the instructions are further configured to cause the one or more processors to:
train the NN model to minimize a final loss function determined based on either the first loss function, the second loss function, or the third loss function.

18. The electronic device of claim 11, wherein the instructions are further configured to cause the one or more processors to:
output a source vector corresponding to the source data by receiving the source data;
output a target vector corresponding to the target data by receiving the target data;
predict the first latent target data by receiving the source vector and the target vector; and
predict the second latent target data by receiving the source vector.

19. The electronic device of claim 11, wherein the source data and the target data comprise time-series data.

20. The electronic device of claim 11, wherein the NN model is configured to operate as a teacher model and is configured to operate as a student model.
